(19) United States
(12) Patent Application Publication
(10) Pub. No.: US 2025/0014144 A1
(43) Pub. Date: Jan. 9, 2025

(54) PHYSICS-INFORMED ADAPTIVE FOURIER NEURAL INTERPOLATION OPERATOR FOR SYNTHETIC FRAME GENERATION

(71) Applicant: Purdue Research Foundation, West Lafayette, IN (US)

(72) Inventors: Aniket Bera, West Lafayette, IN (US); Rashmi Bhaskara, West Lafayette, IN (US); Md Ashiqur Rahman, West Lafayette, IN (US); Hrishikesh Viswanath, West Lafayette, IN (US)

(21) Appl. No.: 18/758,927

(22) Filed: Jun. 28, 2024

Related U.S. Application Data
(60) Provisional application No. 63/511,755, filed on Jul. 3, 2023.

(51) Int. Cl. G06T 3/4046; G06T 3/4007

(52) U.S. Cl. CPC G06T 3/4046; G06T 3/4007

(57) ABSTRACT

A neural operator-based architecture for performing synthetic frame generation is introduced. The architecture leverages the principles of physics to learn the features in the frames, independent of input resolution, through token mixing and global convolution in the Fourier spectral domain by using Fast Fourier Transform (FFT). The architecture overcomes one of the common limitations exhibited by models that use convolutional layers, a variance to scale, and makes the model resolution independent. This approach is particularly relevant in cases where hardware and resource limitations prevent the capture of high frame rate videos.

This application claims the benefit of priority of U.S. provisional application Ser. No. 63/511,755, filed on Jul. 3, 2023 the disclosure of which is herein incorporated by reference in its entirety.

### FIELD

The device and method disclosed in this document relates to synthetic frame generation and, more particularly, to a physics-informed adaptive Fourier neural interpolation operator for synthetic frame generation.

### BACKGROUND

Unless otherwise indicated herein, the materials described in this section are not admitted to be the prior art by inclusion in this section.

Video frame interpolation is an intricate process that generates one or more intermediate frames from a given set of available frames. This problem presents significant challenges due to the necessity of comprehending the geometric structures of images, predicting the positions of numerous objects within the images, and accounting for the complex velocities of these objects and the time steps between frames. In the context of biology and physics, this process can be compared to understanding the dynamic motion of biological systems, such as cellular structures or the interactions of particles in a fluid medium. From the perspective of scientific computing, addressing the challenge of video frame interpolation requires the development of advanced algorithms and architectures that can efficiently handle the complex and dynamic nature of the problem.

Video frame interpolation has broad applicability in scientific research. For example, the challenges associated with video capture in various scientific applications, such as wildlife monitoring, remote sensing, microscopy, underwater research, and space exploration, often necessitate the use of low frame rate or low-resolution videos. For instance, trail cameras placed in natural habitats are designed to conserve battery life and storage space, leading to lower frame rates and resolutions. Similarly, remote sensing platforms, such as satellites or aerial vehicles, face data transmission limitations that can result in reduced video quality. In the field of microscopy, imaging hardware constraints and the need to minimize data generation during extended observation periods can lead to lower frame rates and resolutions. Underwater research and exploration also demand video capture devices that can operate efficiently under challenging environmental conditions, such as low light levels or limited visibility, which may require lower frame rates and resolutions. Finally, space exploration probes and rovers often employ cameras that prioritize conserving power and storage resources, as well as accommodating limited bandwidth for data transmission back to Earth, resulting in lower frame rates and resolutions. In such video capture applications, video frame interpolation can be adopted to improve the quality of the video while operating within the constraints of the application.

Outside of scientific applications, many recent works focus on increasing video frame rate to improve gaming and real-time video streaming experiences. Most of these applications, especially video streaming applications and gaming environments, involve the interpolation algorithm running on the network edge while also involving very high-resolution videos. Several cutting-edge models have been developed, and they produce interpolated frames that, on average, have a structural similarity of 98% with the expected output but are trained on small patches of input. However, it is very expensive computationally to train neural networks on high-resolution inputs.

Several other applications can also make use of video frame interpolation. For example, video frame interpolation can be used to generate movies and panoramic views from visually similar frames. Additionally, video frame interpolation can be used in applications that run on the network edge that may need to recover lost frames due to network issues or to restore broken videos.

Utilizing neural networks as a solution to interpolation offers a low-cost solution, as devices only need to store the model weights, which are typically a few hundred megabytes in size. Current deep learning-based interpolation models generally take the form of convolutional neural networks. These models construct the missing frames by extracting the structural information present in the input images using the appropriate filters or kernels. Convolutional layers exhibit shift invariance as they capture objects present in different regions of the image. However, neural networks relying solely on convolutional filters face limitations in generalizing well to scaling. This is due to the fixed size of the filters, which can only recognize patterns that conform to their dimensions. Moreover, convolutional neural network-based models are not invariant to rotation. To overcome the latter issue, images are randomly flipped and rotated to capture different orientations of the same object. Finally, convolutional neural network-based models rely on local convolution for feature learning and require large amounts of training data and take a long time to converge. There have been attempts to solve this issue, for example, video interpolation using cyclic frame generation techniques, but they are not very accurate.

Optical flow-based techniques, which capture the motion of objects, have also been applied to video frame interpolation. In this technique, the apparent motion of the pixels is captured and labeled as a flow vector. Using the estimated values of these flow vectors for each pixel, a missing frame can be generated. Flow-based techniques resolve the limitations imposed by inadequate kernel sizes in CNN-based methods and the frames can also be generated at a higher frame rate, resulting in a smoother video. However, optical flow-based methods fail while dealing with noisy frames due to the lack of necessary pixel information.

It has also been observed that a combination of both kernel-based and optical flow-based methods with deep-learning techniques like transformers and generative adversarial networks (GAN) have low frame interpolation errors and also provide a great frame rate for a smooth video. However, GAN-based architectures suffer from modal collapse and thus cannot be generalized in an arbitrary fashion. They rely heavily on the distribution of input and would require re-training for a new distribution if the input space is changed. Transformer-based architectures have been shown to be very efficient. However, due to their massively complex architecture, they require a lot of computing power and powerful GPUs to train. Long training times are an additional downside.

What is needed is an efficient video interpolation system that is compatible with commonly used devices, that can operate on edge hardware, and that can accommodate videos of any arbitrary resolution.

### SUMMARY

A method for synthetic image frame generation is disclosed. The method comprises receiving, with a processor, a first image frame and a second image frame from a video source, the second image frame being subsequent to the first image frame. The method further comprises determining, with the processor, based on the first image frame and the second image frame, a first interpolated latent representation using a first neural network. The method further comprises determining, with the processor, based on the first interpolated latent representation, a second interpolated latent representation using a second neural network, the second neural network including a neural operator having spectral convolution layers configured to perform global convolution operations in a frequency domain. The method further comprises generating, with the processor, an interpolated image frame based on the first interpolated latent representation and the second interpolated latent representation.

A non-transitory computer-readable medium that stores program instructions for synthetic image frame generation is disclosed. The program instructions are configured to, when executed by a processor, cause the processor to receive a first image frame and a second image frame from a video source, the second image frame being subsequent to the first image frame. The program instructions are configured to, when executed by the processor, further cause the processor to determine, based on the first image frame and the second image frame, a first interpolated latent representation using a first neural network. The program instructions are configured to, when executed by the processor, further cause the processor to determine, based on the first interpolated latent representation, a second interpolated latent representation using a second neural network, the second neural network including a neural operator having spectral convolution layers configured to perform global convolution operations in a frequency domain. The program instructions are configured to, when executed by the processor, further cause the processor to generate an interpolated image frame based on the first interpolated latent representation and the second interpolated latent representation.

### BRIEF DESCRIPTION OF THE DRAWINGS

The foregoing aspects and other features of the methods and systems are explained in the following description, taken in connection with the accompanying drawings.

FIG. 1 summarizes the architecture of a video interpolation model configured to synthesize frames from low frame rate video sources.

FIG. 2 shows an exemplary embodiment of the computing device that can be used to implement the AdaFNIO network.

FIG. 3 shows a flow diagram for a method for synthetic image frame generation.

FIG. 4A shows the constituent layers of the AdaCoF subnetwork.

FIG. 4B shows the constituent layers of the neural operator subnetwork.

FIG. 5 shows a comparison of performance of deep learning-based models on Vimeo90K dataset against the number of epochs.

FIG. 6 shows a table summarizing the quantitative performance against other state-of-the-art models.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

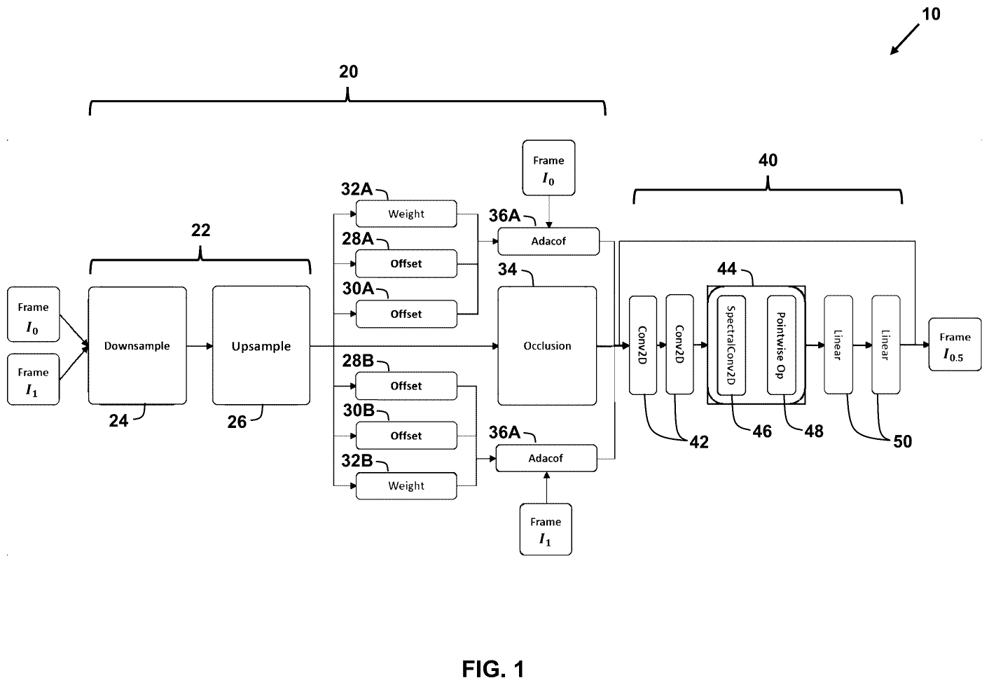

FIG. 1 summarizes the architecture of a video interpolation model 10 configured to synthesize frames from low frame rate video sources. Such videos may include scientific recordings such as brain MRI, photosynthesis, blood flow simulations, and the like. The video interpolation model 10 advantageously leverages a neural operator-based architecture for interpolating video frames through token mixing, which has a quasi-linear complexity and is independent of input resolution. This design of the video interpolation model 10 tackles the problem of video interpolation from a physics perspective. The problem can be defined as predicting the trajectories of objects, each moving with a different velocity in continuous space, similar to optical flow. However, the video interpolation model 10 captures the flow information efficiently using kernels.

The video interpolation model 10 is also referred to herein as the Adaptive Fourier Neural Interpolation Operator (AdaFNIO) network 10. With reference to FIG. 1, the AdaFNIO network 10 comprises two subnetworks: an AdaCoF subnetwork 20 and a neural operator subnetwork 40. Particularly, the AdaCoF subnetwork 20 is based on the Adaptive Collaboration of Flows, or AdaCoF, network, proposed in “Adacof: Adaptive collaboration of flows for video frame interpolation” by Lee et al (2020). In summary, the AdaCoF subnetwork 20 is an interpolation network, which performs a linear operation on two image frames and couples them together with a common weight matrix. The AdaCoF network is designed to improve the degrees of freedom of complex motions in the image frames. The AdaCoF architecture offers a very generalized solution to determining optical flows, irrespective of the number of pixels and their location in the frame.

However, in order to generalize the AdaCoF subnetwork 20 to any arbitrary resolution, the AdaFNIO network 10 extends upon the AdaCoF subnetwork 20 by adding neural operator layers to capture finer information that is otherwise hard to generalize at higher resolutions. The neural operator subnetwork 40 is a modified version of the U-NO network, as proposed in “U-NO: U-shaped neural operators” by Rahman et al (2023). In summary, the neural operator subnetwork 40 performs global convolution operations in the Fourier Space (i.e., the frequency domain).

The AdaFNIO network 10 is a powerful, efficient neural operator-based architecture configured to perform video frame interpolation whose performance is comparable to state-of-the-art interpolation models. Meanwhile, the AdaFNIO network 10 has several key advantages over prior works. Particularly, the AdaFNIO network 10 leverages the fact that learning in the Fourier domain allows for resolution-independent learning and allows for generalization to high-resolution images to capture finer details in high-resolution images that are harder to capture. Additionally, the AdaFNIO network 10 incorporates insights from physics and scientific computing, which enables a more accurate and robust solution for video frame interpolation that accounts for the intricacies of diverse systems and processes. Moreover, since the AdaFNIO network 10 is also scale-invariant, it can greatly benefit scientific applications by enabling the accurate generation of intermediate frames, irrespective of the input video resolution. This would allow for more precise motion analysis, improved data visualization, and enhanced temporal resolution in low frame rate or low-resolution videos. Additionally, the AdaFNIO network 10 eliminates the need for extensive data preprocessing or resolution-specific model training, making it a versatile solution across different fields and video capture devices.

The AdaFNIO network 10 can be applied to a variety of scientific observations, animations and simulations to show how machine learning based approaches can provide a way to overcome hardware and resource limitations in recording scientific observations. Additionally, experimental results have shown that the AdaFNIO network 10 generates high-resolution frames that are both sharp and free of motion artifacts, even in the absence of high frame rate data. The quality of the results were quantified using the Peak Signal to Noise Ratio (PSNR) and the Structural Similarity Index and show that the SSIM of the generated frames is structurally similar to the ground truth. The AdaFNIO network 10 has been shown to generalize well on unseen data by testing it on the DAVIS-90, the UCS101, and the DISFA+ datasets.

### Exemplary Hardware Embodiment

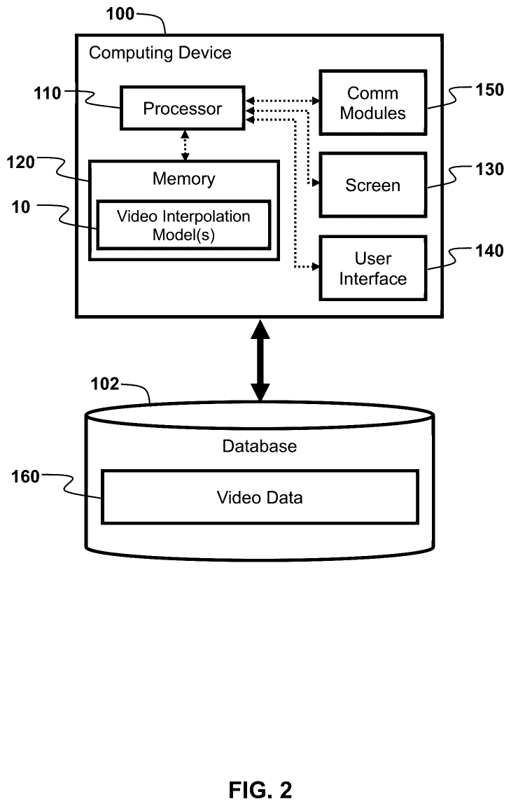

FIG. 2 shows an exemplary embodiment of the computing device 100 that can be used to implement the AdaFNIO network 10. Likewise, the computing device 100 might also be used to train the AdaFNIO network 10. The computing device 100 comprises a processor 110, a memory 120, a display screen 130, a user interface 140, and at least one network communications module 150. It will be appreciated that the illustrated embodiment of the computing device 100 is only one exemplary embodiment and is merely representative of any of various manners or configurations of a server, a desktop computer, a laptop computer, mobile phone, tablet computer, or any other computing devices that are operative in the manner set forth herein. In at some embodiments, the computing device 100 is in communication with a database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of the AdaFNIO network 10 that, once trained, are configured to process low frame rate videos to synthesize additional frames. In at least some embodiments, the database 102 stores a plurality of video data 160, which may include a plurality of three frame training sequences in which the first and third frames in each sequence are used as training inputs, and the second frame in each sequence is treated as the ground truth output for the training.

### Methods for Synthetic Frame Generation

A variety of operations and processes are described below for operating the computing device 100 to use the AdaFNIO network 10 to perform a synthetic frame generation and/or video interpolation task. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

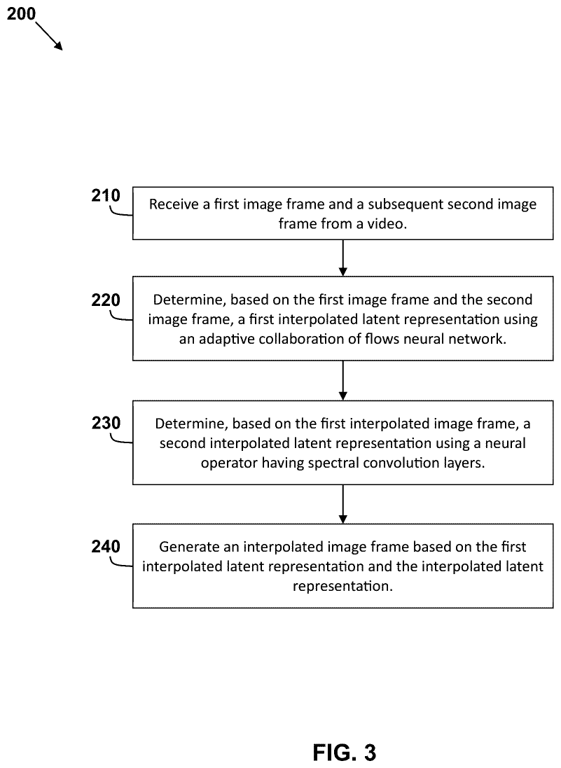

FIG. 3 shows a flow diagram for a method 200 for synthetic image frame generation. The method 200 advantageously overcomes one of the common limitations exhibited by models that use convolutional layers, a variance to scale, and makes the model resolution independent. The method 200 advantageously generates new frames by capturing the flow and trajectories of the constituent objects. This approach is particularly relevant in cases where hardware and resource limitations prevent the capture of high frame rate videos. The method 200 advantageously imposes resolution invariance through spectral convolution layers.

The method 200 begins with receiving first image frame and a subsequent second image frame from a video (block 210). Particularly, the processor 110 of the computing device 110 receives a first image frame I₀ and a second image frame I₁ from a video source. The second image frame I₁ is subsequent to, and preferably immediately sequential to, the first image frame I₀ in the video source. It should be appreciated that the video source can take a variety of forms including any time sequence of image frames, such as a recorded video file, an internet video stream, a live video camera feed, a real-time video rendering pipeline (e.g., a video game), and the like. The processor 110 provides the image frames I₀ and I₁ to the two input channels of the AdaFNIO network 10.

The method 200 continues with determining, based on the first image frame and the second image frame, a first interpolated latent representation using an adaptive collaboration of flows neural network (block 220). Particularly, the processor 110 of the computing device 110 determines, based on the image frames I₀ and I₁, a first interpolated latent representation using a first neural network, in particular using an adaptive collaboration of flows (AdaCoF)-based neural network. The first interpolated latent representation is denoted AdaCoF(I₀, I₁), where AdaCoF( ) is the operation performed by the AdaCoF subnetwork 20. The AdaCoF subnetwork 20 acts as an interpolation layer, which performs a linear operation on the input image frames I₀ and I₁ and couples them together with a common weight matrix to arrive at the first interpolated latent representation AdaCoF(I₀, I₁).

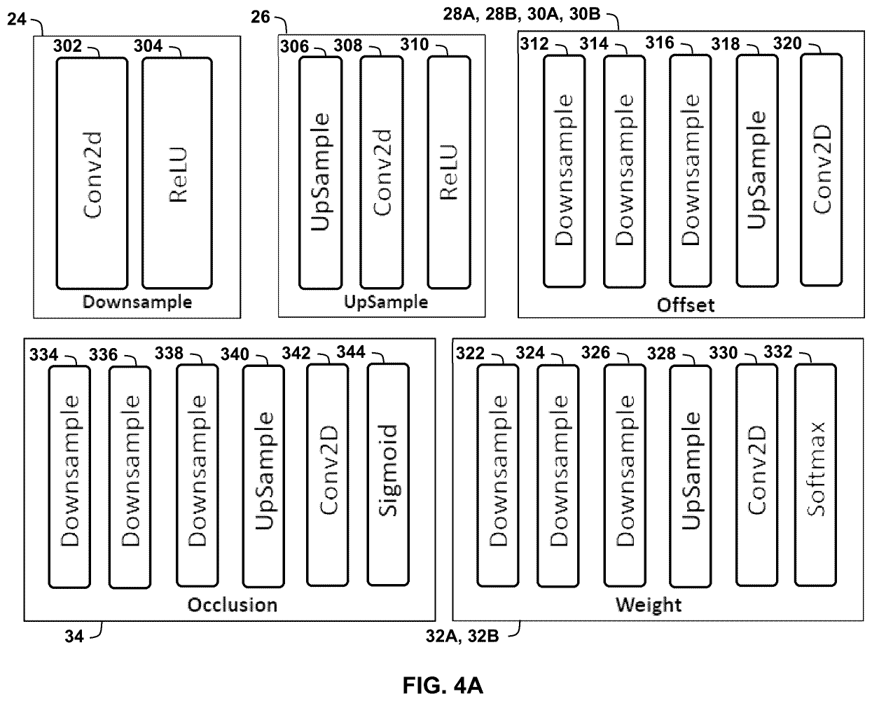

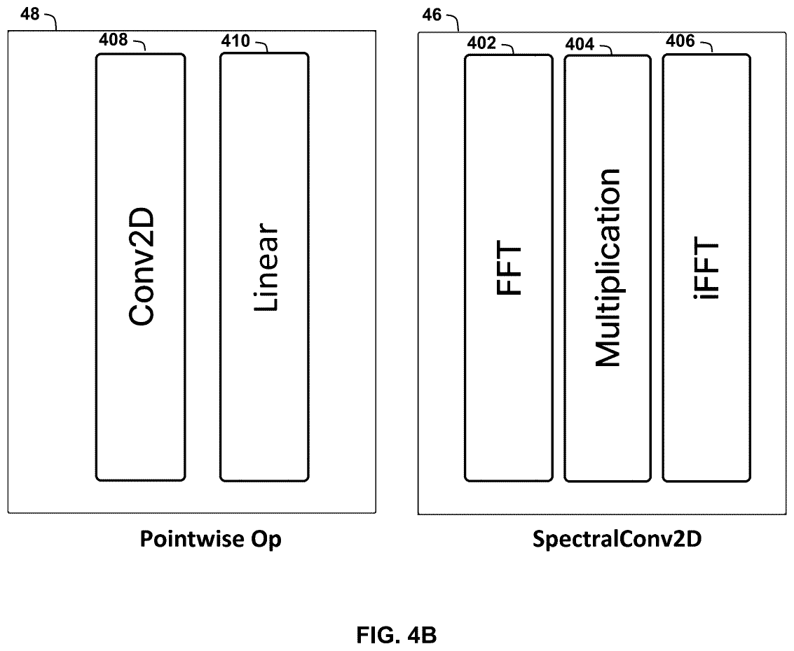

First, the processor 110 extracts key features from the input image frames I₀ and I₁ using a neural network encoder-decoder of the AdaCoF subnetwork 20. Particularly, with reference again to FIG. 1, the AdaCoF subnetwork 20 includes a U-net 22 formed by a downsample network 24 and an upsample network 26, each comprising convolutional layers. The input space is initially contracted by the downsample network 22, which acts as an encoder to extract the key features of the input image frames I₀ and I₁ to generate a latent representation having a dimensionality reduction. With reference to FIG. 4A, in some embodiments, the downsample network 22 comprises one or more convolution layers 302 followed by rectified linear unit (ReLU) activation 304. Next, the latent representation is fed to the upsample network 24, which acts as a decoder to reconstruct the frame from the latent representation, which is expanded back to the original image dimensions. With reference to FIG. 4A, in some embodiments, the upsample network 24 has a sequence of upsample layers 306 and convolution layers 308 followed by rectified linear unit (ReLU) activation 310.

Next, the processor 110 determines adaptive weights and offsets representing transformations from the input image frames I₀ and I₁ to respective interpolated latent representations. Particularly, with reference again to FIG. 1, the AdaCoF subnetwork 20 includes two sets of three networks, each set comprising two offset networks 28A/28B, 30A/30B and one weight network 32A/32B. With reference to FIG. 4A, in some embodiments, the offset networks 28A, 28B, 30A, 30B each comprise a sequence of downsample layers 312, 314, 316, followed by an upsample layer 318, and finally concluding with a convolution layer 320. In some embodiments, the weight networks 32A, 32B each comprise a sequence of downsample layers 322, 324, 326, followed by an upsample layer 328, followed by a convolution layer 330, and finally concluding with a softmax layer 332.

The reconstructed frame from the U-net 22 is fed to offset networks 28A, 30A to determine offset vectors α₀ and β₀, respectively. Additionally, the reconstructed frame from the U-net 22 is fed to the weight network 32A to determine an adaptive weight matrix W₀. The offset vectors α₀ and β₀ and the adaptive weight matrix W₀ collectively represent a spatial transformation between the image frame I₀ and a respective interpolated latent representation. Similarly, the reconstructed frame from the U-net 22 is fed to offset networks 28B, 30B to determine offset vectors α₁ and β₁, respectively. Finally, the reconstructed frame from the U-net 22 is fed to the weight network 32B to determine an adaptive weight matrix W₁. The offset vectors α₁ and β₁ and the adaptive weight matrix W₁ collectively represent a spatial transformation between the image frame I₁ and a respective interpolated latent representation.

Next, the processor 110 determines an occlusion map V that identifies pixels that are present in the first image frame I₀ but not the second image frame I₁ and identifies pixels that are present in the second image frame I₁ but not the first image frame I₀. With reference again to FIG. 1, the AdaCoF subnetwork 20 includes an occlusion network 34. With reference to FIG. 4A, in some embodiments, the occlusion network 34 comprises a sequence of downsample layers 334, 336, 338, followed by an upsample layer 340, followed by a convolution layer 342, and finally concluding with a softmax layer 344. The reconstructed frame from the U-net 22 is fed to the occlusion network 34 to determine an occlusion map V. In at least one embodiment, the occlusion map V takes the form Vϵ[0,1]^{M×N}, where M×N is the dimensions of the image frames I₀ and I₁, and a value V(i,j)=1 implies that the pixel (i,j) is only visible in the image frame I₀ and a value V(i,j)=0 implies that the pixel (i,j) is only visible in the image frame I₁.

Next, the processor 110 determines a respective interpolated latent representation to by applying the offset vectors α₀ and β₀ and the adaptive weight matrix W₀ to the first image frame I₀. Likewise, the processor 110 determines a respective interpolated latent representation ti by applying the offset vectors α₁ and β₁ and the adaptive weight matrix W₁ to the second image frame I₁. With reference again to FIG. 1, the AdaCoF subnetwork 20 includes AdaCoF layers 36A, 36B. AdaCoF layers 36A, 36B are configured to warp a respective image frame I by convolving it with offsets α, β and weights W to arrive at a respective interpolated latent representation Î. In at least one embodiment, the AdaCoF layers 36A, 36B perform an operation according to:

$$\hat{I} ( i , j ) = {\sum }_{k = 0}^{F - 1} {\sum }_{l = 0}^{F - 1} {W}_{k , l} ( i , j ) I ( i + k + {α}_{k , l} , j + l + {β}_{k , l} )$$

where I is an input image, F is the kernel size, W_{k,l}(i,j) are the kernel weights for respective pixels (i,j) of the input image I, (α_{k,l}, β_{k,l}) are offset vectors, and Î is an output interpolated latent representation.

Finally, the processor 110 determines the first interpolated latent representation AdaCoF(I₀, I₁) by combining the respective interpolated latent representation Î₀ and the respective interpolated latent representation Î₁ using the occlusion map V. In at least one embodiment, the processor 110 applies the following logic to combine account for occlusion between the frames:

$${I}_{out} = V ⊙ {\hat{I}}_{0} + ( J - V ) ⊙ {\hat{I}}_{1}$$

where ⊚ is a pixel-wise multiplication, J is an M×N matrix of ones, and Iₒᵤₜ is the final output of the AdaCoF subnetwork 20, i.e. the first interpolated latent representation AdaCoF(I₀, I₁).

With reference again to FIG. 3, the method 200 continues with determining, based on the first interpolated latent representation, a second interpolated latent representation using a neural operator having spectral convolution layers (block 230). Particularly, the processor 110 determines, based on the first interpolated latent representation AdaCoF(I₀, I₁), a second interpolated latent representation using a second neural network having a neural operator. The second interpolated latent representation is denoted [symbol] (I₀, I₁), where [symbol] ( ) is the operation performed by the neural operator subnetwork 40. With reference again to FIG. 1, the neural operator subnetwork 40 includes a neural operator 44 having a sequence of spectral convolution layers 46 configured to perform global convolution operations in the Fourier Space (i.e., in the frequency domain) to capture finer information that is otherwise hard to generalize at higher resolutions. Additionally, to account for non-periodicity in images, a local convolution layer is added after each global convolution, which take the form of pointwise operation layers 48.

The neural operator subnetwork 40 receives the first interpolated latent representation AdaCoF(I₀, I₁) (i.e., the final output of the AdaCoF subnetwork 20) as its input. The processor 110 extracts a plurality of tokens from the first interpolated latent representation AdaCoF(I₀, I₁). With reference again to FIG. 1, the neural operator subnetwork 40 includes a sequence of local convolution layers 42. The local convolution layers 42 apply a linear operator to the first interpolated latent representation AdaCoF(I₀, I₁) to extract a plurality of tokens. Each token in the plurality of tokens corresponds to a respective patch of the first interpolated latent representation AdaCoF(I₀, I₁). In at least one embodiment, the local convolution layers 38 have shared weights.

As mentioned above, the input to the AdaFNIO network 10 is a set of frames, which are images. Neural operators have been traditionally applied to solve partial differential equations or PDEs where the input is the discretization of a continuous vector field. Images, on the other hand, have distinct objects, sharp edges and discontinuities. The frames can be broken down into a set of tokens, where each token is a patch within the frame. The tokens are extracted in the initial local convolution layers 42 with shared weights. The kernel size and the stride length determine the dimensions of the tokens.

Next, once the plurality of tokens is extracted from the first interpolated latent representation AdaCoF(I₀, I₁), the processor 110 determines the second interpolated latent representation [symbol] (I₀, I₁) based on the plurality of tokens using the neural operator 44. As noted above, the neural operator 44 has a sequence of spectral convolution layers 46 and pointwise operation layers 48. Each spectral convolution layers 46 performs a global convolution as a token mixing operation in the Fourier space. Each respective pointwise operation layer 48 performs local convolution and resizes the output of the preceding spectral convolution layer 46 to the required dimensions. The processor 110 determines the output of each layer in the neural operator 44 as a weighted sum of the output of the respective spectral convolution layer 46 and the output of the respective pointwise operation layer 48.

The neural operator 44 of the neural operator subnetwork 40 learns the mapping between two infinite dimensional spaces from a finite collection of input-output pairs. For video frame interpolation, the infinite spaces are the functions corresponding to the trajectories of the constituent objects while the input-output pairs are the triplets representing micromovement samples.

Let [symbol] and [symbol] be the two such function spaces. Any frame a is sampled from [symbol] , and the corresponding output frame u is sampled from [symbol] . The neural operator 44, denoted here as [symbol] , learns the mapping between a and u. The neural operator [symbol] is an approximation of the function mapping [symbol] from [symbol] to [symbol] . The input image frames are treated as a collection of a continuous set of tokens, which are fed to the layers that perform token mixing to generate an embedding. The output features are generated from the low-dimensional embedding. The neural operator is a sequence of [symbol] ₜ, for each layer tϵ{1, 2, . . . N}, each of which is a linear integral operator followed by non-linear activation. A kernel function is used within the integral operation and this becomes the basis of global convolution. The overall operation is given by:

$${𝒢}_{t} {v}_{t} ( x ) = σ ( \int {t - 1}_{} ( x , y ) {v}_{t - 1} d {μ}_{t} ( y ) + {W}_{t} {v}_{t - 1} ( x ) ) ,$$

where [symbol] ᵢ is the kernel function with measure μᵢ, which along with the integral operator, performs a global linear operation, W performs the point-wise linear operation, a is the non-linear activation, and vₜ is the output of layer t.

Iterative updates are performed as denoted by:

$${v}_{t + 1} ( x ) = σ ( {Wv}_{t} ( x ) + ( {K}_{ϕ} {v}_{t} ) ( x ) ) ,$$

where σ is the non-linear activation, W is the linear transformation and K is the kernel operator parameterized by ϕ.

The kernel operator is not explicitly represented in the spatial domain but is learned in the Fourier space directly through FFT (Fast Fourier Transform) and is represented as a periodic function R. The learned features are then added to the features learned by a point-wise operator through regular 2D convolution. This process is represented in:

$${v}_{t + 1} ( x ) = {ℱ}^{- 1} ( {R}_{ϕ} \cdot ℱ ( {v}_{t} ) ) ( x ) ,$$

where R is the Fourier transform of a periodic function parameterized by ϕ, [symbol] denotes the Fourier Transform, and [symbol] ⁻¹ denotes the inverse Fourier Transform.

The Fourier Transform is given by:

$${( ℱ f )}_{j} ( k ) = {\int }_{D} {f}_{j} ( k ) {e}^{- 2 i π 〈 x , k 〉} dk .$$

Likewise, the inverse Fourier Transform is given by:

$${( {ℱ}^{- 1} f )}_{j} ( k ) = {\int }_{D} {f}_{j} ( k ) {e}^{2 i π 〈 x , k 〉} dk .$$

The above equations are Fourier Transforms in continuous space. However, images are discrete and, therefore, Fast Fourier Transforms are applied.

The Fast Fourier transform in d-dimensional space is given by:

$${( \hat{ℱ} f )}_{l} ( k ) = {\sum }_{{x}_{1} = 0}^{{s}_{1} - 1} … {\sum }_{{x}_{d} = 0}^{{s}_{d} - 1} {f}_{l} ( {x}_{1} … {x}_{d} ) {e}^{- 2 i π {\sum }_{j = 1}^{d} \frac{{x}_{j} {k}_{j}}{{s}_{j}}} .$$

Likewise, the Inverse Fast Fourier Transform in d-dimensional space is given by:

$${( {\hat{ℱ}}^{- 1} f )}_{l} ( k ) = {\sum }_{{k}_{1} = 0}^{{s}_{1} - 1} … {\sum }_{{k}_{d} = 0}^{{s}_{d} - 1} {f}_{l} ( {k}_{1} … {k}_{d} ) {e}^{2 i π {\sum }_{j = 1}^{d} \frac{{x}_{j} {k}_{j}}{{s}_{j}}} .$$

Finally, the convolution operation in the Fourier space with the kernel tensor R, then becomes point-wise multiplication and is denoted by:

$${( R ( ℱ {v}_{t} ) )}_{k , l} = {\sum }_{j = 1}^{{d}_{v}} {{R}_{k , l , j} ( ℱ {v}_{t} )}_{k , j} .$$

In at least one embodiment, the neural operator 44 takes the form of an encoder-decoder having a downsampler block (not shown) followed by an upsampler block (not shown). In contrast to regular convolution to perform downsampling and upsampling, the neural operator 44 uses spectral convolution to perform feature extraction and dimensionality reduction in Fourier space which is followed by Gaussian Error Linear Unit (GELU) activation function to recover high-frequency information.

Through a sequence of spectral convolution layers 46 and pointwise operator layers 48, the downsampler block of the neural operator 44 determines a latent embedding of the plurality of tokens. In one embodiment, the neural operator 44 includes one or more initial convolution layers prior to the downsampler block that are configured to generate latent representations before processing by the downsampler block. The downsampler block has a predetermined number of contraction layers (e.g., four contraction layers) that, in each case, reduce the dimensions of the input, for example from 256×256 to 32×32. In one embodiment, the number of Fourier modes retained in each contraction layer are 42, 21, 10, and 5, respectively. Each contraction layer includes a respective spectral convolution layer 46 and a respective pointwise operation layer 48.

Through a further sequence of spectral convolution layers 46 and pointwise operator layers 48, the upsampler block of the neural operator 44 determines an interpolated latent representation that will subsequently be used to determine the final output of the neural operator subnetwork 40, i.e., the second interpolated latent representation [symbol] (I₀, I₁). The upsampler block is symmetric to the downsampler block and has the predetermined number of expansion layers (e.g., four expansion layers) that, in each case, expand the dimensions of the input, for example from 32×32 to 256×256. In one embodiment, the number of Fourier modes retained in each expansion layer are 5, 10, 21, and 42, respectively. Each expansion layer includes a respective spectral convolution layer 46 and a respective pointwise operation layer 48.

With reference to FIG. 4B, each respective spectral convolution layer 46 includes a Fast Fourier Transform (FFT) layer 402 that performs a Fourier transformation of the respective input tensor to the particular spectral convolution layer 46, followed by a pixel-wise multiplication layer 404 that performs a pixel-wise multiplication in the Fourier domain on an output of the FFT layer 402, and followed by an inverse Fast Fourier Transform (FFT) layer 406 that performs an inverse Fourier transformation of an output of the pixel-wise multiplication layer 404. In at least some embodiments, the multiplication is done on the lower (kₓ, k_{y}) Fourier modes, which is restricted to be at most (n/2, m/2), where (n, m) is the resolution of the image. If the weight matrix has a dimension of (p, p), then the time complexity of global convolution is O(N log(N)p²), where N is the length of the token sequence. With continued reference to FIG. 4B, each respective pointwise operation layer 48 includes a local convolution layer 408 configured to perform a local convolution operation to account for non-periodicity in images, as well as a linear layer 410.

Finally, with reference again to FIG. 1, the spectral convolution layers 46 and pointwise operation layers 48 of the neural operator 44 are followed by a sequence of linear layers 50 that output the second interpolated latent representation [symbol] (I₀, I₁). In at least one embodiment, the linear layers 50 of the neural operator subnetwork 40 operate to resize the output.

In summary, the processor 110 generates the second interpolated latent representation [symbol] (I₀, I₁) according to the following. Let the input frames be represented as I₀ and I₁, and the AdaCoF network be represented by AdaCoF( ). Let the downsampler block of the neural operator 44 be represented as E and the upsampler block of the neural operator 44 be represented as D. The pipeline is as follows:

[symbol]

(I₀,I₁)=D(E(AdaCoF(I₀,I₁)))

It should be appreciated that the spectral convolution layers 46 advantageously learn to process the token features in the Fourier space, which is invariant to the resolution of the input image. This allows the AdaFNIO network 10 to exhibit the property of zero-shot super-resolution. That is, the AdaFNIO network 10 can be trained on one resolution and tested on any arbitrary resolution. The spectral convolution layers 46 of the neural operator subnetwork 40 only preserve the low-frequency Fourier modes and ignores the high-frequency modes, which are too specific to the particular input and if these modes are learned, they overfit to the input. After applying the weights, the tensors are projected back into the spatial domain and non-linear activation is applied to recover the high-frequency points. This process is analogous to token mixing. The spectral convolution architecture of the AdaFNIO network 10 is also similar to an autoencoder network where the encoder layers contract the input space to capture the key information about the distribution of the input and the decoder expands it back to its original input space.

The method 200 continues with generating a final interpolated image frame based on the first interpolated latent representation and the second interpolated latent representation (block 240). Particularly, the processor 110 generates a final interpolated image frame I_{0.5} based on the first interpolated latent representation AdaCoF(I₀, I₁) and the second interpolated latent representation [symbol] (I₀, I₁). In at least one embodiment, the processor determines the final interpolated image frame I_{0.5} as a summation of the first interpolated latent representation AdaCoF(I₀, I₁) and the second interpolated latent representation [symbol] (I₀, I₁), according to:

$${I}_{0.5} = D ( E ( AdaCoF ( {I}_{0} , {I}_{1} ) ) ) + AdaC oF ( {I}_{0} , {I}_{1} ) ,$$

$${I}_{0.5} = 𝒩 ( {I}_{0} , {I}_{1} ) + AdaCoF ( {I}_{0} , {I}_{1} ) ,$$

In at least one embodiment, the processor determines the final interpolated image frame I_{0.5} as a weighted summation of the first interpolated latent representation AdaCoF(I₀, I₁) and the second interpolated latent representation [symbol] (I₀, I₁), according to:

$${I}_{0.5} = {w}_{1} 𝒩 ( {I}_{0} , {I}_{1} ) + {w}_{2} AdaC oF ( {I}_{0} , {I}_{1} ) ,$$

where w₁ and w₂ are weights chosen for the features generated by the AdaCoF subnetwork 20 and the neural operator subnetwork 40, respectively, which are tuned during training.

After generating the final interpolated image frame I_{0.5}, it can be used to provide video having a higher frame rate. Particularly, in some embodiments, the processor 110 operates the display screen 130 to display video including the interpolated image frame I_{0.5} situated in time between the first image frame I₀ and the second image frame I₁. In another embodiment, the processor 110 writes to the memory 120 a video file that includes the interpolated image frame I_{0.5} situated in time between the first image frame I₀ and the second image frame I₁. In another embodiment, the processor 110 operates the network communications module 150 to transmit a video stream that includes the interpolated image frame I_{0.5} situated in time between the first image frame I₀ and the second image frame I₁.

### Training the AdaFNIO Network

Both the AdaCoF subnetwork 20 and the neural operator subnetwork 40 of the AdaFNIO network 10 are trained simultaneously together to generate interpolated image frames. In at least one embodiment, a processor of a computing device trains the AdaFNIO network 10 in a supervised fashion by feeding pairs of input image frames from a video into the AdaFNIO network 10 and determining an output interpolated image frame. Particularly, as mentioned above, a plurality of video data 160 may be stored in a database 102, which may include a plurality of three frame training sequences in which the first and third frames in each sequence are used as training inputs, and the second frame in each sequence is treated as the ground truth output for the training.

The output interpolated image frame is compared with a ground-truth intermediate image frame (e.g., an actual image frame the was captured by a camera between the pair of input image frames). Based on the training loss, for each training sample, parameters (e.g., kernel weights, model coefficients, etc.) of the AdaFNIO network 10 are updated and refined until satisfactory performance is achieved by the AdaFNIO network 10.

In one embodiment, the AdaFNIO network 10 is trained using two loss functions. Firstly, during an initial training phase, the AdaFNIO network 10 is trained using an L₁ loss function. This loss is given by:

$${L}_{1} = {‖ {I}_{AdaFNIO} - {I}_{G T} ‖}_{1} ,$$

where I_{AdaFNIO} is the output interpolated image frame from the AdaFNIO network 10 and I_{GT} is the ground-truth intermediate image frame.

Secondly, during a fine-tuning phase after the initial training phase, the AdaFNIO network 10 is fine-tuned using a perceptual loss function. The perceptual loss is generated by the feature extractor of the pre-trained VGG22 neural network. This loss is given by:

$${L}_{vgg} = ‖ F ( {I}_{AdaFNIO} ) - F ( {I}_{GT} ) ‖ ,$$

where F(I_{AdaFNIO}) are features extracted from I_{AdaFNIO} by the feature extractor of the pre-trained VGG22 neural network and F(I_{GT}) are features extracted from I_{GT} by the feature extractor of the pre-trained VGG22 neural network.

The overall loss function used during the fine-tuning phase is a combination of L₁ and L_{vgg} loss functions, with higher weights given to the L₁ loss function. This is, for example, given by:

$$L = {L}_{1} + 0.01 * {L}_{vgg} .$$

### Experimental Results

To demonstrate the improved quality of the video frames generated using the AdaFNIO network 10, comprehensive experiments were conducted. More particularly, the AdaFNIO network 10 was validated on three frequently used benchmark datasets, Vimeo90K, DAVIS, and UCF101, as well as validated on one specialty dataset, DISFA+, which focuses on videos with human faces.

For training the AdaFNIO network 10, the Vimeo90K triplet dataset was used. The Vimeo90K dataset is built from 89,800 clips taken from the video streaming site Vimeo. It contains a large variety of scenes. The dataset has 73,171 3-frame sequences, of which 58,536 frames were used for training and the remaining 14,635 were used for validation, all of which have a resolution of 448×256. The L1 loss was used for the first 80 epochs. For the finetuning process, 11,000 random frames were used to tune the model for another 20 epochs with perceptual loss. The model was tested against 1080p stock footage of a Japanese landscape taken from the YouTube channel 8K World. This video was chosen because the footage was shot in very high resolution. The model was trained for 100 epochs on an Nvidia A100 GPU. The frames were randomly cropped to 256×256 patches. However, the frames were not randomly flipped, scaled, or rotated in order to test the invariance properties of the AdaFNIO network 10.

The Davis-90 and UCF101 datasets were used to test the performance of the model. The Davis-90 (Densely Annotated Video Segmentation) dataset contains frames from various scenes. These frames are partitioned into triplet sets and used for testing the performance of the model. Additionally, the preprocessed UCF101 dataset is a collection of scenes that have been partitioned into triplets. This dataset is also used for testing the models.

The DISFA+(Denver Intensity of Spontaneous Facial Action) dataset consists of a large set of facial expression sequences, both posed and non-posed. The dataset has multiple subjects of different ethnicities exhibiting various facial expressions and is a comprehensive dataset to study micro facial expressions. This dataset was chosen due to the increase in the prevalence of video meetings and social media videos, many of which predominantly features human faces. The DISFA+ dataset was processed into triplets and the model was trained to predict the second frame from the first and third frames. The Vimeo90K dataset was used to provide a comparison benchmark against other deep learning-based interpolation approaches, while the DISFA+ dataset was used to predict facial expressions from up close. This served as a test to determine the ability of neural operator-based models to interpolate minute facial muscle movements. The frames were resized to 256×256 due to memory and GPU constraints.

The AdaFNIO network 10 was built using Pytorch and trained on Nvidia A100 GPUs. The Fourier modes used for the spectral convolution layers are 5, 10, 21 and 42. The batch size was set to 32 and the learning rate was set to 0.0001. The weight for the NIO base model was set to 0.01. The training was done using Cuda 11.0. Adam optimizer was used with a weight decay of 0.0001, β₁ of 0.9 and β₂ of 0.999. The loss function used for training was a mean squared error (MSE) or L2 Loss.

The qualitative performance of the AdaFNIO network 10 was tested to provide a comparison benchmark against the other state-of-the-art models with SSIM and PSNR as the evaluation metrics. The interpolated frame quality can be measured as PSNR(I′_{0.5}, I_{0.5}) and SSIM(I′_{0.5}, I_{0.5}), where I′_{0.5} is the ground truth.

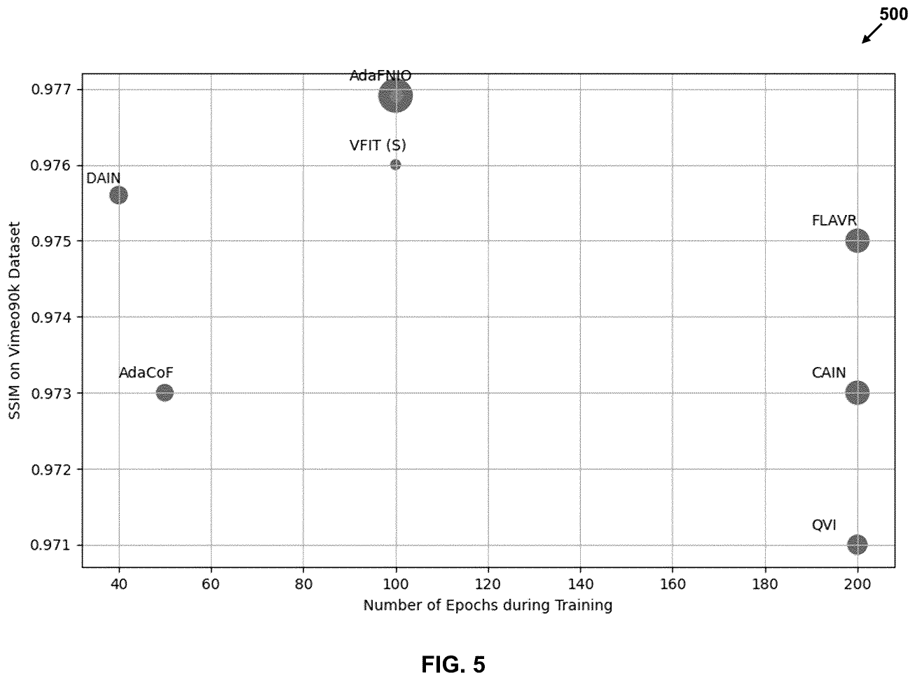

FIG. 5 shows a plot 500 comparing performance of deep learning-based models on the Vimeo90K dataset against the number of epochs. As can be seen, the AdaFNIO network 10 achieves comparable accuracy within just 100 epochs.

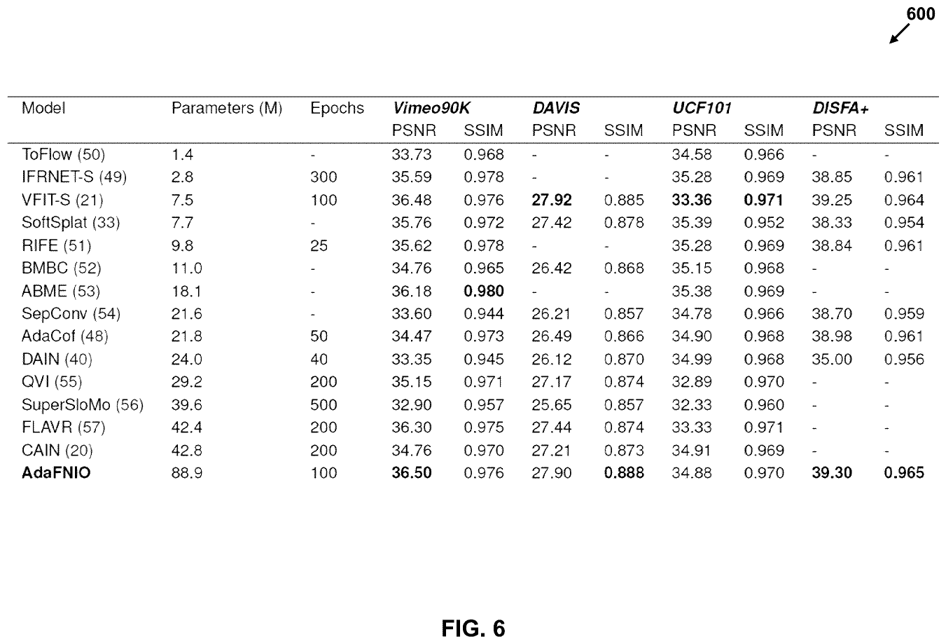

FIG. 6 shows a table 600 summarizing the quantitative performance against other state-of-the-art models, using the Vimeo90K, DAVIS, UCF101 and DISFA+ datasets. The AdaFNIO network 10 has the best PSNR (36.50) on the Vimeo90K dataset, and the best SSIM (0.888) on the DAVIS dataset and outperforms every other model against the DISFA+ dataset. The reason for better performance against the DISFA+ dataset is that neural operator-based models perform well on periodic images with smooth edges. Talking head videos have the fewest number of objects and fewer edges within the frames and thus, neural operators outperform in that situation.

Qualitatively, the images generated by the AdaFNIO network 10 are indistinguishable from the ground truth images. However, further experiments were performed against the baseline AdaCoF model to test the extent of generalization at higher resolutions. The AdaFNIO network 10 had better SSIM and PSNR values when applied to higher-resolution videos. The quantitative differences were determined between the frames generated by the AdaCoF model and the AdaFNIO network 10 in two settings—varying resolutions and varying frame rates. The models were tested against the Japanese stock footage video at 30 fps, with 9,894 frames.

Varying resolutions—At lower resolution, we observed that the AdaFNIO network 10 and the AdaCoF model had similar performance but as the resolution increased, the AdaFNIO network 10 performed slightly better than the AdaCoF model. Table 1, below, shows the SSIM values against the Japanese stock footage video captured at different resolutions

TABLE 1

| Model | 480p | 720p | 1080p |
|---|---|---|---|
| AdaFNIO | 98.276 | 98.792 | 99.207 |
| AdaCoF | 98.276 | 98.790 | 99.199 |

Varying frame rates and missing frames—To test the performance of the AdaFNIO network 10 with missing frames, the AdaFNIO network 10 was evaluated in three settings against 480p resolution frames: where every alternate frame was dropped, where 2 consecutive frames were dropped and where 4 consecutive frames were dropped. The AdaFNIO network 10 slightly outperformed the AdaCoF model in all three settings. Table 2, below shows the SSIM values against the Japanese stock footage video captured at fixed resolution of 480p but with varying frame rates.

TABLE 2

| Model | drop 1 | drop 2 | drop 3 |
|---|---|---|---|
| AdaFNIO | 98.257 | 94.909 | 89.988 |
| AdaCoF | 98.256 | 94.899 | 89.969 |

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for synthetic image frame generation, the method comprising:
receiving, with a processor, a first image frame and a second image frame from a video source, the second image frame being subsequent to the first image frame;
determining, with the processor, based on the first image frame and the second image frame, a first interpolated latent representation using a first neural network;
determining, with the processor, based on the first interpolated latent representation, a second interpolated latent representation using a second neural network, the second neural network including a neural operator having spectral convolution layers configured to perform global convolution operations in a frequency domain; and
generating, with the processor, an interpolated image frame based on the first interpolated latent representation and the second interpolated latent representation.

2. The method according to claim 1, the determining the first interpolated latent representation further comprising:
determining first weights and first offsets representing a transformation from the first image to a third interpolated latent representation;
determining the third interpolated latent representation based on the first image, the first weights, and the first offsets;
determining first weights and first offsets representing a transformation from the second image to a fourth interpolated latent representation;
determining the fourth interpolated latent representation based on the second image, the second weights, and second offsets; and
determining the first interpolated latent representation by combining the third interpolated latent representation and the fourth interpolated latent representation.

3. The method according to claim 2, the determining the first interpolated latent representation further comprising:
extracting features from the first image frame and the second image frame using a neural network encoder-decoder.

4. The method according to claim 3, the determining the first interpolated latent representation further comprising:
determining the first weights and the first offsets based on the extracted features; and
determining the second weights and the second offsets based on the extracted features.

5. The method according to claim 2, the determining the first interpolated latent representation further comprising:
determining an occlusion map that (i) identifies pixels that are present in the first image frame but not the second image frame and (ii) identifies pixels that are present in the second image frame but not the first image frame.

6. The method according to claim 5, the determining the first interpolated latent representation further comprising:
determining the first interpolated latent representation by combining the third interpolated latent representation and the fourth interpolated latent representation, using the occlusion map.

7. The method according to claim 1, wherein the first neural network is configured to output the first interpolated latent representation by performing adaptive collaboration of flows operations on the first image frame and the second image frame.

8. The method according to claim 1, the determining the second interpolated latent representation further comprising:
extracting a plurality of tokens from the first interpolated latent representation; and
determining, based on the plurality of tokens, the second interpolated latent representation using the neural operator of the second neural network.

9. The method according to claim 8, wherein each token in the plurality of tokens corresponds to a respective patch of the first interpolated latent representation.

10. The method according to claim 8, the extracting the plurality of tokens further comprising:
extracting the plurality of tokens using at least one convolutional layer.

11. The method according to claim 8, determining the second interpolated latent representation using a neural operator further comprising:
determining the second interpolated latent representation by performing, with the spectral convolution layers of the second neural network, the global convolution operations in the frequency domain on the plurality of tokens.

12. The method according to claim 11, the performing the global convolution operations further comprising:
determining a latent embedding of the plurality of tokens by performing a first sequence of global convolution operations in the frequency domain on the plurality of tokens, the first sequence of global convolution operations being configured to downsample the plurality of tokens; and
determining the second interpolated latent representation by performing a second sequence of global convolution operations in the frequency domain on the latent embedding of the plurality of tokens, the second sequence of global convolution operations being configured to upsample the latent embedding of the plurality of tokens.

13. The method according to claim 12, the performing the global convolution operations further comprising:
performing, after each global convolution operation, a local convolution operation with pointwise operation layers of the second neural network.

14. The method according to claim 12, the performing the global convolution operations further comprising, for each respective global convolution operation:
performing a Fourier transformation of a respective input tensor of the respective global convolution operation;
perform a pixel-wise multiplication in the Fourier domain on an output of the Fourier transformation; and
performing an inverse Fourier transformation of an output of the pixel-wise multiplication.

15. The method according to claim 12, determining the second interpolated latent representation using a neural operator further comprising:
resizing the second interpolated latent representation using at least one linear layer following the second sequence of global convolution operations.

16. The method according to claim 1, the generating the interpolated image frame further comprising:
generating the interpolated image frame as a weighted summation of the first interpolated latent representation and the second interpolated latent representation.

17. The method according to claim 1, wherein the video source is one of a video file, a video stream, or a video rendering pipeline.

18. The method according to claim 1 further comprising:
operating a display screen to display video including the interpolated image frame situated in time between the first image frame and the second image frame.

19. The method according to claim 1, wherein the first neural network and the second neural network are trained simultaneously together to generate interpolated image frames.

20. A non-transitory computer-readable medium that stores program instructions for synthetic image frame generation, the program instructions being configured to, when executed by a processor, cause the processor to:
receive a first image frame and a second image frame from a video source, the second image frame being subsequent to the first image frame;
determine, based on the first image frame and the second image frame, a first interpolated latent representation using a first neural network;
determine, based on the first interpolated latent representation, a second interpolated latent representation using a second neural network, the second neural network including a neural operator having spectral convolution layers configured to perform global convolution operations in a frequency domain; and
generate an interpolated image frame based on the first interpolated latent representation and the second interpolated latent representation.
